(19) United States
(12) Patent Application Publication
(10) Pub. No.: US 2007/0118625 A1
(43) Pub. Date: May 24, 2007

(54) Upnp av device interworking method of upnp-based network system

(76) Inventors: Ku-Bong Min, Seoul (KR); Sung-Joon Ahn, Gyeonggi-Do (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 10/573,847

(22) PCT Filed: Oct. 7, 2004
(86) PCT No.: PCT/KR04/02563

§ 371 Date: Mar. 27, 2006

(30) Foreign Application Priority Data
Oct. 11, 2003 (KR) 10-2003-0070867

(51) Int. Cl. G06F 15/177

(52) U.S. Cl. 709/221

(57) ABSTRACT

Disclosed is a UPnP AV device interworking method of a UPnP-based network system which allows UPnP AV devices located on different networks to interwork with each other. Applications of the UPnP devices are widely expanded at a low cost by transforming a private address to a public address by URI address transformation between the UPnP AV devices located on a home network and a common internet.

### TECHNICAL FIELD

The present invention relates to a Universal Plug and Play (UPnP)-based network system, and more particularly to, a UPnP AV device interworking method of a UPnP-based network system which allows a UPnP AV device located on a common internet and a UPnP AV device located on a home network to interwork (operate) with each other.

### BACKGROUND ART

With the advance of information technologies, various IT products such as cellular phones, digital TV sets, PDAs and game machines as well as PCs are connected to each other through a network. As such a network environment is expanded to houses, a home network gains popularity. Especially, the UPnP gets influential in mutual control and administration of home network devices.

The UPnP is a common protocol prepared by improving a plug and play function, so that various network devices of different standards and specifications can interface each other. That is, the UPnP allows various home appliances connected to a network, namely, network devices such as a network printer and an internet gateway to network each other on the basis of internet standard technologies such as TCP/IP, HTTP and XML.

In general, the UPnP network system basically includes a UPnP device, a service and a control point (CP), and streams, stores and manages multimedia contents. Here, the UPnP device includes a service and a few sub-devices. For example, a TV/VCR combo device may include a tape transfer service, a tuner service and other built-in devices. The service implies a small-scale control unit on the network system which can model a self state by using state variables. For example, a time model may include a state variable for defining a current time state and a variable for controlling a service. In addition, the CP implies a controller having functions of sensing and controlling the UPnP devices composing the UPnP.

On the other hand, the UPnP is embodied on the basis of the standards defined by the UPnP forum (http://www.UPnP.org) according to UPnP Device Architecture 1.0 distributed by Microsoft Corporation.

The UPnP forum that leads establishment of the standards of the UPnP devices and services is composed of six working groups. Among the six working groups, the Audio/Video (A/V) working group includes a media server (MS) for providing media data to a home network, a media renderer (MR) for playing back the media data through the home network, and an audio/video control point (AV CP) for controlling the MS and the MR.

FIG. 1 is a block diagram illustrating a general UPnP AV network system.

The operation of the general UPnP device based on the specification of the UPnP AV Device Architecture 1.0 will now be explained with reference to FIG. 1.

An AV CP 110 selects contents of an MS 120 by using a user interface (UI), and then selects a target MR 130. The selected contents are transmitted directly from the MS 120 to the MR 130 by out-of-band streaming. Here, the MS 120 provides one or more transfer protocols, and data formats for each contents item. A contents type which the MR 130 can receive is dependent upon a transfer protocol and a data format supported by the MR 130.

The CP 110 activates AVTransport actions (for example, Stop, Pause, FF, REW, Skip and Scan), and controls various rendering (Brightness, Contrast, Volume and Balance) of the MR 130.

However, the UPnP AV network-system-based on the UPnP Device Architecture 1.0 is embodied on the presumption that the AV CP, the MS and the MR are located and operated on the home network. Accordingly, the UPnP devices located on a common internet are not allowed to interwork (operate) with each other.

### DISCLOSURE OF THE INVENTION

Therefore, an object of the present invention is to provide a UPnP AV device interworking method of a UPnP-based network system which allows UPnP devices to interwork (operate) with each other by transforming a private address to a public address by Uniformed Resource Identifier (URI) address transformation, when some of the UPnP devices exist on an internet.

To achieve these and other advantages and in accordance with the purpose of the present invention, as embodied and broadly described herein, in a UPnP-based network system in which UPnP AV devices are located on a home network and a common internet, respectively, a UPnP AV device interworking method of the UPnP-based network system transforms a private address to a public address between the UPnP AV devices located on the home network and the common internet, respectively.

According to one aspect of the present invention, in a UPnP-based network system in which UPnP AV devices are located on a home network and a common internet, respectively, a UPnP AV device interworking method of the UPnP-based network system includes the steps of: obtaining, at a CP controlling the UPnP AV devices, a URI of contents located on the home network; transforming, at the CP, a private address of the URI to a public address; and receiving and playing back, at the UPnP AV device located on the common internet, predetermined contents by streaming on the basis of the transformed address.

According to another aspect of the present invention, in a UPnP-based network system in which UPnP AV devices are located on a home network and a common internet, respectively, a UPnP AV device interworking method of the UPnP-based network system includes the steps of: obtaining an address of the UPnP AV device located on the home network; confirming the UPnP AV device located on the common internet by referring to description information; notifying the address of the UPnP AV device located on the home network to the UPnP AV device located on the common internet; and playing back contents selected by the user by transmitting the contents from the UPnP AV device located on the common internet to the UPnP AV device located on the home network by pushing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a general UPnP AV network system;

FIG. 2 is a structure diagram illustrating a UPnP AV device control system in which a CP and an MR are located on a common internet and an MS is located on a home network in accordance with a first embodiment of the present invention;

FIG. 3 is a structure diagram illustrating a UPnP AV device control system in which a CP and an MS are located on a home network and an MR is located on a common internet in accordance with a second embodiment of the present invention;

FIG. 4 is a structure diagram illustrating a UPnP AV device control system in which a CP and an MS are located on a common internet and an MR is located on a home network in accordance with a third embodiment of the present invention; and

FIG. 5 is a structure diagram illustrating a UPnP AV device control system in which a CP and an MR are located on a home network and an MS is located on a common internet in accordance with a fourth embodiment of the present invention.

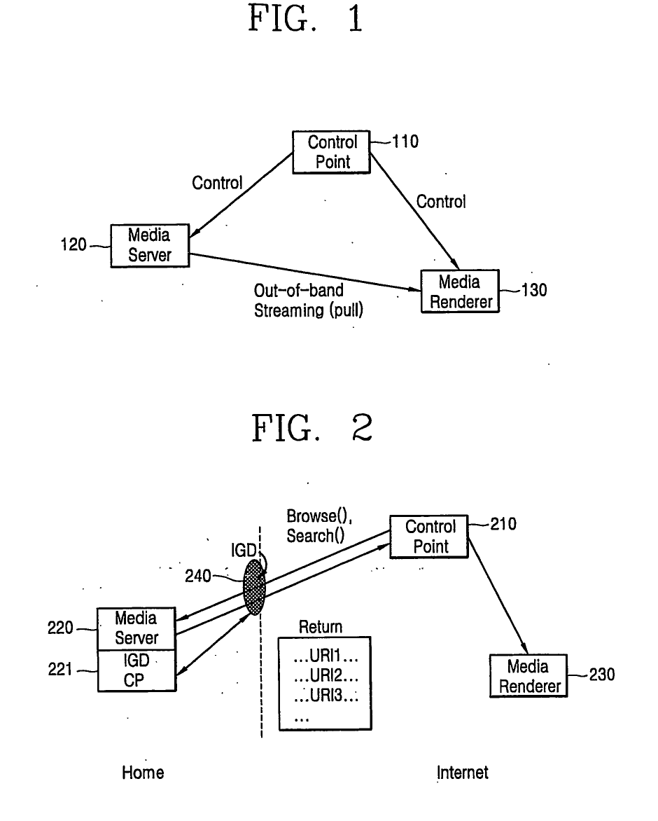

### MODES FOR CARRYING OUT THE PREFERRED EMBODIMENTS

Reference will now be made in detail to the preferred embodiments of the present invention, examples of which are illustrated in the accompanying drawings.

When some of UPnP devices exist on an internet, the UPnP devices can interwork (operate) with each other by transforming a private address to a public address by URI address transformation. Here, an MS and an MR that are UPnP AV devices are located on different networks, and a CP for controlling the UPnP AV devices is located on any one of a home network and a common internet.

In accordance with the present invention, the UPnP AV device, the CP or an Internet Gateway Device (IGD) for connecting the CP and the UPnP AV device performs the URI address transformation. The URI address transformation implies transformation of an IP address and a port by Network Address Transform (NAT). In the case of an in-band streaming protocol, the CP performs the URI address transformation and in the case of an out-of-band streaming protocol, the UPnP AV device performs the URI address transformation, which is advantageous in the processing speed.

On the other hand, when the CP is located on the home network and intends to control the UPnP AV device located on the common internet, it is presumed that the CP know a description address according to a well-known address method or a dynamic Domain Name Service (DNS) method. It is also presumed that the CP accesses the UPnP AV device located on the common internet by using the description address. It is still presumed that the UPnP AV device located on the common internet does not broadcast a search message for UPnP addressing or discovery and does not respond to an M-search message. It is still presumed that, when the CP located on the home network and the UPnP AV device located on the common internet are connected to each other, the CP or the UPnP AV device performs port mapping.

FIG. 2 is a structure diagram illustrating a UPnP AV device control system in which a CP and an MR are located on a common internet, an MS is located on a home network, and an IGD for connecting the CP and the MS is included in accordance with a first embodiment of the present invention.

As illustrated in FIG. 2, the MS 220 includes a UPnP IGD CP 221, and the IGD 240 connects the CP 210 located on the common internet and the MS 220 located on the home network. Here, the IGD 240 is an independent gateway device or a personal computer (PC) serving as a gateway.

The operation of the UPnP AV device control system in accordance with the first embodiment of the present invention will now be described.

The CP 210 located on the common internet is connected to the MS 220 through the IGD 240 by confirming a description address including a list on devices and services. In order to obtain an address of predetermined contents from the MS 220, the CP 210 transmits Browse( ) or Search( ) action to the MS 220 through the IGD 240. The MS 220 transmits an action return value including a URI to the CP 210 through the IGD 240, and the CP 210 selects the MR 230 to play back the contents. Finally, when the contents are transmitted from the MS 220 to the MR 230 under the control of the CP 210, the MR 230 plays back the contents.

In order for the MR 230 located on the common internet to play back the contents, a private address must be transformed to a fixed address. Such address transformation is performed by transformation of the IP address and the port by the NAT.

When the CP 210 located on the common internet and the MS 220 located on the home network are connected to each other, the NAT is set up by the UPnP IGD CP 221 included in the MS 220. In addition, any one of the MS 220, the CP 210 and the IGD 240 for connecting the CP 210 and the MS 220 can perform the address transformation of the URIs included in the return values of Browse( ) and Search( ) actions.

The URI address transformation can be performed on the whole URIs or the URIs selected by the user (on-the-fly). Most preferably, the URI address transformation is performed on the URIs selected by the user by the CP 210 in consideration of the processing speed. That is, in the case of an in-band streaming protocol, the CP performs the URI address transformation, and in the case of an out-of-band, streaming protocol, the UPnP AV device performs the URI address transformation, which is advantageous in the processing speed.

For example, it is presumed that the CP 210 selectively performs the URI address transformation. When the user selects URI3, the CP 210 transforms the address of the URI3, and the MR 230 streams the contents corresponding to the address of the URI3 from the MS 220 by pulling. Here, the NAT port mapping for out-of-band streaming has already been allocated by the MS 220.

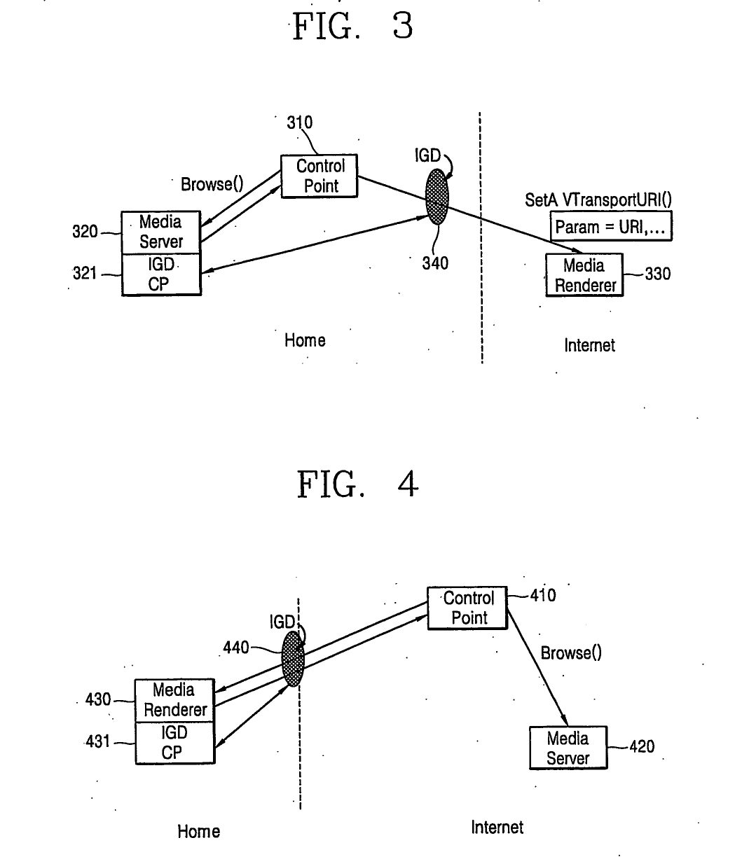

FIG. 3 is a structure diagram illustrating a UPnP AV device control system in which a CP and an MS are located on a home network and an MR is located on a common internet in accordance with a second embodiment of the present invention.

As shown in FIG. 3, the MS 320 includes a UPnP IGD CP 321, and an IGD 340 connects the CP 310 located on the home network and the MR 330 located on the common internet. Here, the IGD 340 is an independent gateway device or a PC serving as a gateway.

The operation of the UPnP AV device control system in accordance with the second embodiment of the present invention will now be described.

The CP 310 located on the home network confirms a description address including a list on devices and services, and transmits Browse( ) action to the MS 320 located on the home network to obtain an address of predetermined contents. The MS 320 transmits an action return value including a URI to the CP 310. The CP 310 selects the MR 330 located on the common internet to play back the contents, and transmits SetAVTransportURI( ) action to the MR 330 through the IGD 340.

Finally, the MR 330 streams and plays back the contents from the MS 320. Here, in order for the MR 330 located on the common internet to play back the contents, the CP 310 located on the home network transforms a URI address of the SetAVTransportURI( ) action into a fixed address.

The address transformation is performed by the NAT. When the CP 310 located on the home network and the MS 320 located on the common internet are connected to each other, the NAT is set up by the UPnP IGD CP 321 included in the MS 320. As described in the first embodiment, the MS 320, the IGD 340 or the CP 310 can perform the URI address transformation. Also, the CP 310 can perform the address transformation on the URIs selected by the user.

Finally, the MR 330 streams the contents corresponding to the address of the URI transformed by the CP 310 from the MS 320 by puling. Here, the NAT port mapping for out-of-band streaming has already been allocated by the MS 320.

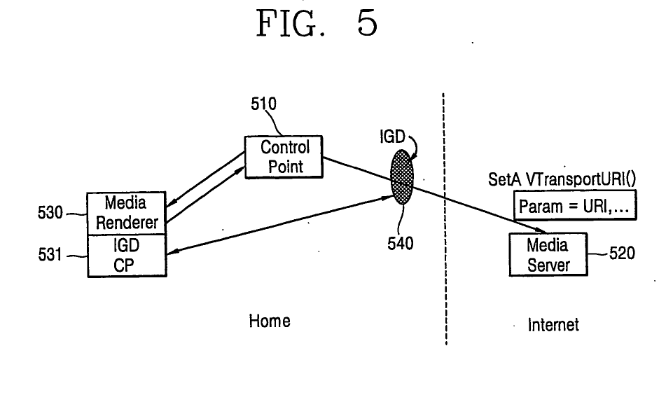

FIG. 4 is a structure diagram illustrating a UPnP AV device control system in which a CP and an MS are located on a common internet and an MR is located on a home network in accordance with a third embodiment of the present invention.

As depicted in FIG. 4, the MS 430 includes a UPnP IGD CP 431, and an IGD 440 connects the CP 410 located on the common internet and the MR 430 located on the home network. Here, the IGD 440 is an independent gateway device or a PC serving as a gateway.

The operation of the UPnP AV device control system in accordance with the third embodiment of the present invention will now be described.

The CP 410 located on the common internet confirms a description address including a list on devices and services, and selects the MR 430 located on the home network through the IGD 440 as a device for playing back contents. When the CP 410 located on the common internet and the MR 430 located on the home network are connected to each other, the NAT is set up to transform a private address to a fixed address by the UPnP IGD CP 431 included in the MR 430.

The CP 410 located on the common internet checks an address of contents of the MS 420 by confirming the previously-known description information, and transmits Browse( ) action to the MS 420 to transmit the contents which the user intends to play back to the MR 430 located on the home network.

Finally, the MS 420 performs contents streaming to the MR 430 by pushing, so that the MR 430 can play back the corresponding contents. Here, the action does not require any URI address transformation.

FIG. 5 is a structure diagram illustrating a UPnP AV device control system in which a CP and an MR are located on a home network and an MS is located on a common internet in accordance with a fourth embodiment of the present invention.

As illustrated in FIG. 5, the MS 530 includes a UPnP IGD CP 531, and an IGD 540 connects the CP 510 located on the home network and the MS 520 located on the common internet. Here, the IGD 540 is an independent gateway device or a PC serving as a gateway.

The operation of the UPnP AV device control system in accordance with the fourth embodiment of the present invention will now be described.

The CP 510 located on the home network confirms a description address including a list on devices and services, and selects the MR 530 located on the home network as a device for playing back contents. When the CP 510 and the MR 530 are connected to each other, the NAT is set up to transform a private address to a fixed address by the UPnP IGD CP 531 included in the MR 530.

The CP 510 located on the home network confirms an address of contents by the description information, and transmits SetAVTransportURI( ) action for selecting playback contents to the MS 520 through the IGD 540. Here, the URI address transformation of the SetAVTransportURI( ) action called by the MS 520 is performed in the same manner as that of the first embodiment of the present invention.

Finally, the MS 520 performs contents streaming to the MR 530 by pushing, so that the MR 530 can play back the corresponding contents.

As discussed earlier, in accordance with the present invention, even if the UPnP AV devices are located on the home network and the common internet respectively, the UPnP AV devices can interwork with other. As a result, applications of the UPnP AV devices can be widely expanded at a low cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. In a UPnP-based network system in which UPnP AV devices are located on a home network and a common internet, respectively, a UPnP AV device interworking method of the UPnP-based network system, which allows the UPnP devices to interwork with each other, by transforming a private address to a public-address by Uniformed Resource Identifier (URI) address transformation between the UPnP AV devices located on the home network and the common internet, respectively.

2. The method of claim 1, further comprising a control point (CP) for controlling the UPnP AV devices located on the home network and the common internet, respectively,
wherein the CP is located on the home network or the common internet.

3. The method of claim 2, wherein any one of the UPnP AV device, the CP and an internet gateway device (IGD) for connecting the CP and the UPnP AV device performs the URI address transformation.

4. The method of claim 3, wherein, in the case of an in-band streaming protocol, the CP performs the URI address transformation, and in the case of an out-of-band streaming protocol, the UPnP AV device performs the URI address transformation.

5. The method of claim 1, wherein the URI address transformation is transformation of an IP address and a port by Network Address Transform (NAT).

6. The method of claim 1, wherein, when the UPnP AV device located on the home network is a media server (MS), the UPnP AV device located on the common internet is a media renderer (MR), the CP for controlling the MR and the MS is located on the common internet, and an IGD for connecting the CP and the MS is included, the CP performs the address transformation of the URIs included in return values of Browse( ) and Search( ) actions from the MS.

7. The method of claim 6, wherein the IGD is an independent gateway device or a personal computer (PC) serving as a gateway.

8. The method of claim 6, wherein the MS, the IGD or the CP performs the address transformation of the URIs included in the return values of the Browse( ) and Search( ) actions.

9. The method of claim 8, wherein the URI address transformation is transformation of an IP address and a port by the NAT, which transforms IP addresses and ports in the whole URIs or the URIs selected by the user (on-the-fly).

10. The method of claim 9, wherein, when the CP and the MS are connected to each other, the NAT is set up by a UPnP IGD CP included in the MS.

11. The method of claim 6, further comprising the steps of:
transmitting, at the CP, Browse( ) or Search( ) action to the MS through the IGD;
transmitting, at the MS, an action return value including a URI to the CP through the IGD; and
playing back, at the MR, the contents under the control of the CP.

12. The method of claim 1, wherein, when the UPnP AV device located on the home network is an MS, the UPnP AV device located on the common internet is an MR, the CP for controlling the MR and the MS is located on the home network, and an IGD for connecting the CP and the MR is included, the CP transforms a URI address of SetAVTransportURI( ) action to a fixed address, so that the MR can play back the contents.

13. The method of claim 1, comprising the steps of:
when the UPnP AV device located on the home network is an MR, the UPnP AV device located on the common internet is an MS, the CP for controlling the MR and the MS is located on the common internet, and an IGD for connecting the CP and the MR is included,
when the CP and the MR are connected to each other, setting up the NAT for transforming the private address to the fixed address by a UPnP IGD CP included in the MR;
confirming, at the CP, an address of contents of the MS on the basis of a description address, and transmitting Browse( ) action to the MS; and
performing, at the MS, contents streaming to the MR by pushing.

14. The method of claim 1, wherein, when the UPnP AV device located on the home network is an MR, the UPnP AV device located on the common internet is an MS, the CP for controlling the MR and the MS is located on the home network, and an IGD for connecting the CP and the MS is included, the CP transforms a URI address of SetAVTransportURI( ) action called from the MS.

15. The method of claim 14, further comprising the steps of:
setting up the NAT for transforming the private address to the fixed address by a UPnP IGD CP included in the MR when the CP and the MR are connected to each other;
confirming, at the CP, an address of contents on the basis of description information, and transmitting SetAVTransportURI( ) action for selecting playback contents to the MS through the IGD; and
performing, at the MS, contents streaming to the MR by pushing.

16. In a UPnP-based network system in which UPnP AV devices are located on a home network and a common internet, respectively, a UPnP AV device interworking method of the UPnP-based network system, comprising the steps of:
obtaining, at a CP controlling the UPnP AV devices, a URI of contents located on the home network;
transforming, at the CP, a private address of the URI to a public address; and
receiving and playing back, at the UPnP AV device located on the common internet, predetermined contents by streaming on the basis of the transformed address.

17. The method of claim 1, wherein the URI address transformation transforms an IP address and a port number of the URI into a public address.

18. In a UPnP-based network system in which UPnP AV devices are located on a home network and a common internet, respectively, a UPnP AV device interworking method of the UPnP-based network system, comprising the steps of:
obtaining an address of the UPnP AV device located on the home network;
confirming the UPnP AV device located on the common internet by referring to description information;
notifying the address of the UPnP AV device located on the home network to the UPnP AV device located on the common internet; and
playing back contents selected by the user, by transmitting the contents from the UPnP AV device located on the common internet to the UPnP AV device located on the home network by pushing.

19. The method of claim 18, wherein the address transformation is transformation of an IP address and a port by the NAT, which is performed by any one of the UPnP AV device, an IGD and the CP.

20. The method of claim 19, wherein, in the case of an in-band streaming protocol, the CP performs the address transformation, and in the case of an out-of-band streaming protocol, the UPnP AV device performs the address transformation.
